(19) United States
(12) Patent Application Publication
(10) Pub. No.: US 2012/0261374 A1
(43) Pub. Date: Oct. 18, 2012

(54) Baby Nipple Device

(76) Inventor: Rolesha Brown, McKinney, TX (US)

(21) Appl. No.: 12/847,054

(22) Filed: Jul. 30, 2010

(51) Int. Cl. A61J 9/00

(52) U.S. Cl. 215/11.1

(57) ABSTRACT

A device for feeding a fluid to a baby may include a nipple to dispense the fluid to the baby and a tubular device to transfer the fluid to the baby. The tubular device may be a straw and the nipple may include an upper torso which flares outwards. The nipple may include a lower torso which flares inwards and the nipple may include a annular indent. The nipple may include a connection device to connect to the tubular device, and the connection device may be expendable. The connection devices may connect to the tubular device by a friction fit.

### FIELD OF THE INVENTION

The present invention is directed to baby-feeding nipples, and, in particular, relates to baby-feeding nipples based on capillary action.

### BACKGROUND

Commercial baby bottle nipples are made in the form of a hollow rubber shell with a feeding-tip extending from a bulbous portion, which is carried on a flexible and pliable outwardly extending flange. The types of nipples on the market differ principally in the number, size, and types of holes or slits in the feeding-tip and in the external shape that fits into the infant's mouth. The prior art nipples have been connected to specifically designed bottles. This design reduces the flexibility of the caretaker to feed the baby different kinds of fluids such as water, juice etc. It would be desirable to allow the baby to withdraw fluid from a packaged source.

It is obvious that there is a need to improve on the current state-of-the-art in baby feeding technology. There have been numerous attempts in the past to improve upon baby-feeding technology, in particular, nipple design. In fact, in the patent literature there are scores of patents in this area, some of which go back more than a century

For more than a century there have been scores of improvement patents for a baby bottle system that delivers fluid to an infant. Some of these have involved the fluid container, others have involved the nipple, and still others have involved both.

Clearly there is a need for a simple, inexpensive baby bottle nipple.

### SUMMARY

A device for feeding a fluid to a baby may include a nipple to dispense the fluid to the baby and a tubular device to transfer the fluid to the baby.

The tubular device may be a straw and the nipple may include an upper torso which flares outwards.

The nipple may include a lower torso which flares inwards and the nipple may include a annular indent.

The nipple may include a connection device to connect to the tubular device, and the connection device may be expendable.

The connection devices may connect to the tubular device by a friction fit.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the nipple and straw of the present invention;

FIG. 2 illustrates a perspective view of the nipple and straw of the present invention.

### DETAILED DESCRIPTION

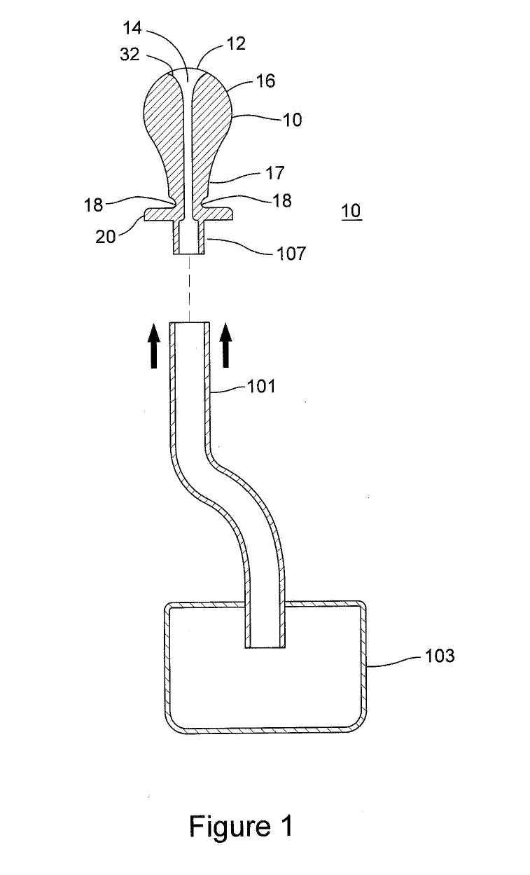

Nipple 10 as shown in FIG. 1 is designed for use in combination with a tubular device 101 for example an elongated straw 101 in order to transfer liquid from a container 103 which may contain liquid such as water, fruit juice or other types of appropriate liquids to the given to a baby, not shown. Nipple 10 has a tip 12 at its top end, shown as rounded, but can be flat or have any shape as is known in the art. Tip 12 has an aperture 14 passing through its center to provide a conduit for the liquid to be dispensed from the bottle. Aperture 14 can be formed in any fashion and of any shape known in the art, such as a slit or slits. Below the rounded tip 12, the nipple 10 flares outward to form an upper torso 16 and flares inward to form a lower torso 17. The lower torso 17 may include an annular indent 18, adjacent its lower end. Below the lower torso 17, nipple 10 may include a radial or horizontal flange 20. Flange 20 assists in mounting nipple 10 in a retaining ring 109, and forms a guard for the nipple 10. Annular indent 18 facilitates alignment and securing of nipple 10 in a retaining ring 109. The nipple 10 may include an expandable connection device 107 which may a hollow cylinder which may include a central passageway to connect the fluid delivery passage 32 to the tubular device 101. The expandable connection device 107 may be formed from flexible material such as rubber and may be sized to approximately the diameter of a straw and may expand as the tubular device 101 is inserted into the connection device 107. A friction connection may result between the connection device 107 and the tubular device 101 to prevent the separation of the nipple 10 and the tubular device 101. A friction connection between the connection device and 107 and the tubular device 101 may be substantially fluid sealed in order to prevent fluid from leaking.

The body of nipple 10 may be solid and may be flexible and may include at least one fluid-delivery passage 32 extending from the termination of tip 12 toward the flange end of nipple body 10 . Each fluid-delivery passage 32 may include a hydrophilic interior surface as to deliver the fluid from the tubular device 101 to a sucking infant on the other end by capillary action.

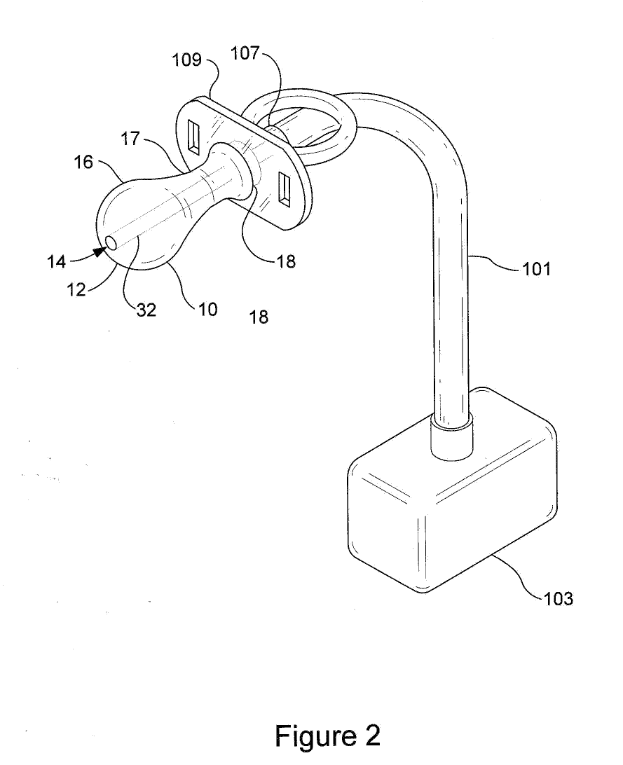

Nipple 10 as shown in FIG. 2 may be designed for use in combination with a tubular device 101 for example an elongated straw in order to transfer liquid from a container 103 which may contain liquid such as water, fruit juice or other types of appropriate liquids to the given to a baby. Nipple 10 has a tip 12 at its top end, shown as rounded, but can be flat or have any shape as is known in the art. Tip 12 has an aperture 14 passing through its center to provide a conduit for the liquid to be dispensed from the bottle. Aperture 14 can be formed in any fashion and of any shape known in the art, such as a slit or slits. Below the rounded tip 12, the nipple 10 flares outward to form an upper torso 16 and flares inward to form a lower torso 17. The lower torso 17 may include an annular indent 18, adjacent its lower end. Below the lower torso 17, nipple 10 may include a radial or horizontal flange 20. Flange 20 assists in mounting nipple 10 in a retaining ring 109, and forms a guard for the nipple 10. Annular indent 18 facilitates alignment and securing of nipple 10 in a retaining ring 109. The nipple 10 may include an expandable connection device 107 which may a hollow cylinder which may include a central passageway to connect the fluid delivery passage 32 to the tubular device 101. The expandable connection device 107 may be formed from flexible material such as rubber and may be sized to approximately the diameter of a straw and may expand as the tubular device 101 is inserted into the connection device 107. A friction connection may result between the connection device 107 and the tubular device 101 to prevent the separation of the nipple 10 and the tubular device 101. A friction connection between the connection device and 107 and the tubular device 101 may be substantially fluid sealed in order to prevent fluid from leaking.

The body of nipple 10 may be solid and may be flexible and may include at least one fluid-delivery passage 32 extending from the termination of tip 12 toward the flange end of nipple body 10 . Each fluid-delivery passage 32 may include a hydrophilic interior surface as to deliver the fluid from the tubular device 101 to a sucking infant on the other end by capillary action.

In this embodiment, the baby bottle nipple may employ microtubes as fluid delivery passages. Microtube technology is disclosed in U.S. Pat. Nos. 5,011,566 and 5,352,512. Briefly, this technology comprises placing a coating on a sacrificial fiber or fibers and then removing the fibers. If the space between the coated fibers is not filled in, tubes will result. However, if the space between the coated fibers has been filled in, capillaries will be produced when the fibers are removed. The inner dimensions and contours of these capillaries will perfectly match the dimensions and contours of the fiber surfaces from which they were formed if the material is rigid.

Nipple 10 is fabricated by placing at least one sacrificial or fugitive fiber in a suitable mold, fixture, extrusion or pultrusion device, with an orientation principally along the axis of the nipple and, if a plurality of fluid-delivery passages are desired, with a desired spacing between pieces of fugitive material. This spacing can be maintained mechanically or by pre-coating the fugitive fiber with the nipple body material, or other suitable material. Sufficient nipple body material is then provided to fill the interstices between the pieces of fugitive material and to form the external dimensions of the nipple body. After solidifying the nipple body material, by appropriate technique, the nipple is removed from the mold, fixture, extrusion, or pultrusion device, and, If necessary, nipple body material is removed to bring the nipple to final external dimensions. Sufficient solidified nipple body material is removed from the tip end and from the flange end to expose the end(s) of the fugitive fiber(s). The fugitive fiber(s) is(are) removed, thereby leaving fluid-delivery passages with interior dimensions equal to or less than the external dimensions of the fugitive material.

Although the fluid-delivery passages 32 in the nipple 10 need to be hydrophilic, it should be noted that the material used to make the nipple 10 body need not be hydrophilic.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A device for feeding a fluid to a baby, comprising:
a nipple to dispense the fluid to the baby;
a tubular device to transfer the fluid to the baby; wherein the nipple includes a connection device to connect to the tubular device, wherein the nipple includes a annular indent and wherein the connection device frictionally connects to the tubular device.

2. A device for feeding a fluid to a baby as in claim 1, wherein the tubular device is a straw.

3. A device for feeding a fluid to a baby as in claim 1, wherein the nipple includes an upper torso which flares outwards.

4. A device for feeding a fluid to a baby as in claim 1, wherein the nipple includes a lower torso which flares inwards.

5. (canceled)

6. (canceled)

7. A device for feeding a fluid to a baby as in claim 6, wherein the connection device is expandable.

8. (canceled)
